(19) United States
(12) Patent Application Publication
(10) Pub. No.: US 2009/0198538 A1
(43) Pub. Date: Aug. 6, 2009

(54) MOBILE ADVERTISEMENT FILTERING

(75) Inventors: Arvind Gupta, San Carlos, CA (US); Ashutosh Tiwari, Studio City, CA (US); Gopalakrishnan Venkatraman, Campbell, CA (US); Dominic Cheung, South Pasadena, CA (US); Stacy R. Bennett, Pasadena, CA (US); Douglas B. Koen, Austin, TX (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/026,531

(22) Filed: Feb. 5, 2008

(51) Int. Cl. G06Q 30/00; G06Q 10/00

(52) U.S. Cl. 705/7

(57) ABSTRACT

Disclosed is a method for filtering mobile ads, including sensing an editorial event from an advertiser user interface, wherein the editorial event comprises an advertiser creating or editing a mobile advertisement listing; enabling submission of the mobile listing multiple channel and carrier attributes; automatically checking the mobile listing with at least one mobile carrier-specific automatic check service in response to the sensed editorial event; determining whether the advertisement listing is flagged for manual review; and sending the mobile listing to a mobile publisher for publishing in response to a determination that the mobile listing is not flagged for manual review.

### TECHNICAL FIELD

The present description relates generally to a system and method, generally referred to as a system, for serving advertisements over mobile devices, and more particularly, but not exclusively, to content filtering advertisements before approval of service of the advertisements through a publisher (or service provider) to one or more mobile devices.

### BACKGROUND

The mobile phone may be increasingly important as an information and content access device. Currently there may be over 2 billion mobile phones globally, versus 800 million personal computers. Mobile operators may be increasingly looking to high value data services as a way to overcome the continuing voice Average Revenue Per User (ARPU) decline. Billions of dollars may be being spent globally on wireless licenses with billions more in investments in the pipeline for development of infrastructure and services by wireless service and content providers. Mobile carriers may be introducing new data, content and multimedia services as a means of generating new revenue stream, reversing negative ARPU trends, retaining and attracting customers as well as increasing returns on investment, and extending and differentiating their service offering to consumers. The emergence of these wireless technologies may be creating unique opportunities for wireless carriers, advertisers and publishers to generate additional revenue streams through new and existing customers. As consumer adoption of wireless technology continues to increase, marketing via mobile devices may become an important part of all integrated data communications strategies.

Mobile marketing may benefit consumers, mobile service providers, publishers and advertisers by driving incremental revenue, enhancing consumer loyalty and providing convenience for mobile consumers. Mobile data acceptance may have arrived in many parts of the World and may be expected to increase. Mobile destination portals such as YAHOO! may monetize the mobile searches.

The global business model of mobile marketing to date may depend upon subscription revenue and purchases of consumables (i.e. ring tones, wallpapers, etc.). Slow roll-out and relatively small incremental revenue streams may be jeopardizing return on investment on current and future investments. Wireless advertising may now be seen as the great hope in accelerating revenue growth, especially given the experience of online web advertising. Search may be emerging as both a key feature and a potential universal interface for discovering and accessing mobile information.

However, usage patterns for mobile search and Web search may differ, as well as the expectations of the users and the advertisers. Combined with a completely different user experience, these may change the value of clicks and lead opportunities. Most current mobile devices may have limited browser capabilities that do not support the rich feature set of the Web. Handset capabilities may impact the search behavior of mobile users, where the limitations of numeric-pad keyed entry narrow the searched for terms. The small screen size on mobile devices may have an impact on the performance of the search implementations. The size of screens on mobile handsets may limit the creative that can be displayed per listing, and the number of listings per screen. Current web search marketing systems may not account for these physical differences between mobile handsets and computers.

The mobile market place may be very fragmented in terms of handset and network technologies, and this may impact the display of listings and advertiser offer sites. For mobile devices, there may not be an HTML-like standard adhered to by all carriers, and the “standards” that are present may tend to be operator specific, and may be incompatible with other “standards.” This may lead to markets within markets, where, for example in Japan, advertisers may create separate sites and campaigns for IMODE users, and XHTML and WML users. This fragmentation may also be barrier to entry for advertisers due to the investment required to support the different technologies and interact with each individual carrier. Advertisers may be faced with either a large start-up investment, or foregoing traffic from certain operators.

### SUMMARY

A system is disclosed for content filtering advertisements before approval of service of the advertisements through a publisher (or service provider) to one or more mobile devices.

According to one aspect, a method is disclosed for filtering mobile ads, including sensing an editorial event from an advertiser user interface, wherein the editorial event comprises an advertiser creating or editing a mobile advertisement listing; enabling submission of the mobile listing multiple channel and carrier attributes; automatically checking the mobile listing with at least one mobile carrier-specific automatic check service in response to the sensed editorial event; determining whether the advertisement listing is flagged for manual review; and sending the mobile listing to a mobile publisher for publishing in response to a determination that the mobile listing is not flagged for manual review.

According to another aspect, a system is disclosed for filtering mobile ads, including a memory to store instructions, a mobile carrier data and an advertisement data. A user interface is operatively connected to the memory to communicate with advertisers that use a mobile device or a web-based computer. A processor is operatively connected to the memory and the user interface to execute the instructions, wherein the processor senses an editorial event comprising an advertiser creating or editing a mobile advertisement listing through the user interface. In response to the sensed editorial event, the processor: enables submission of the mobile listing with a plurality of channel and carrier attributes; automatically checks the mobile listing with at least one mobile carrier-specific automatic check service; flags an advertisement for manual review if the automatic check of the mobile listing indicates that content or format of the mobile listing matches that of a carrier-specific dataset of the at least one automatic check service; and sends the mobile listing to a mobile publisher for publishing if the mobile listing is not flagged for manual review.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for creating and serving advertisements over mobile devices.

FIG. 2 is block diagram of a simplified view of a network environment implementing a system for creating and serving advertisements over mobile devices.

FIG. 3 is a flowchart illustrating steps that may be taken by a revenue generator in the systems of FIG. 1 and FIG. 2, or other systems for serving advertisements over mobile devices.

FIG. 4 is a flowchart illustrating steps that may be taken by a user in the systems of FIG. 1 and FIG. 2, or other systems for serving advertisements over mobile devices.

FIG. 5 is an illustration of a general computer system that may be used in a system for content filtering advertisements before approval of service of the advertisements through a publisher (or service provider) to a mobile device.

FIG. 6 is a screenshot of a revenue generator's account preferences screen in the systems of FIG. 1 and FIG. 2, or other systems for serving advertisements over mobile devices.

FIG. 7 is a screenshot of a revenue generator's listing management screen in the systems of FIG. 1 and FIG. 2, or other systems for serving advertisements over mobile devices.

FIG. 8 is a screenshot of a revenue generator's editorial status screen showing a mobile site URL entry in the systems of FIG. 1 and FIG. 2, or other systems for serving advertisements over mobile devices.

FIG. 9 is a flow chart of a method for content filtering advertisements before approval of service of the advertisements through a publisher (or service provider) to one or more mobile devices.

FIG. 10 is a screen shot of a user interface with a group of editorial graphical user interface (GUI) elements that may be utilized by an editor to review a mobile advertisement listing.

### DETAILED DESCRIPTION

A system and method, generally referred to as a system, relate to serving advertisements over mobile devices, and more particularly, but not exclusively, to serving advertisements targeted to mobile devices of individual mobile network operators. The principles described herein may be embodied in many different forms.

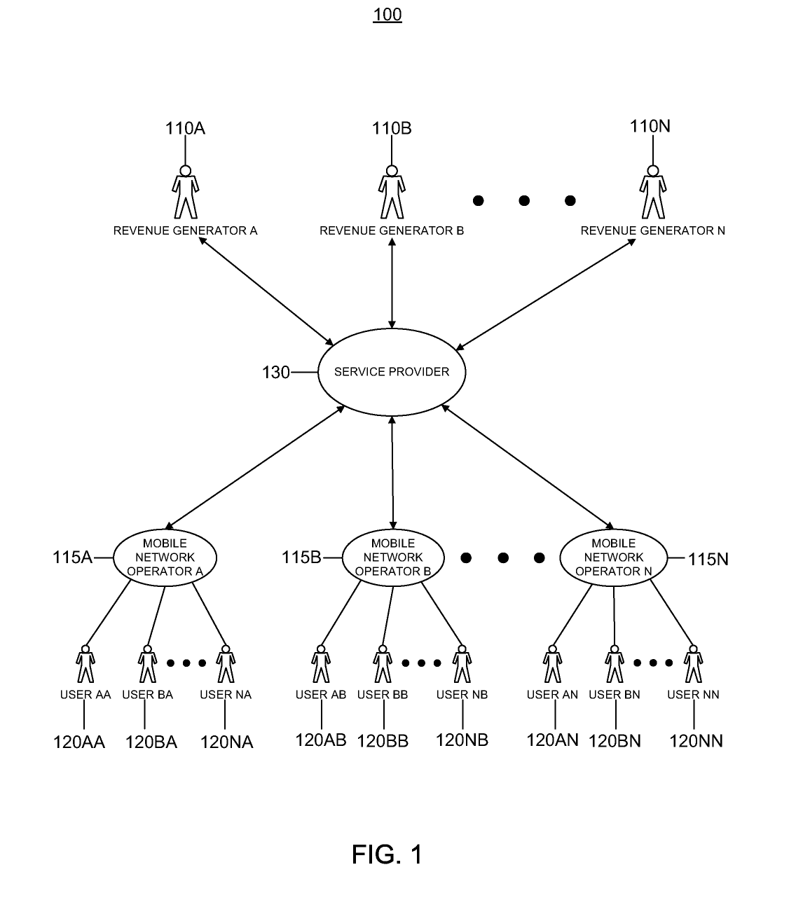

FIG. 1 provides a general overview of a system 100 for serving advertisements over mobile devices. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more revenue generators 110A-N, such as mobile advertisers, a service provider 130, such as a portal, one or more mobile network operators (“MNOs”) 115A-N, more commonly referred to as mobile carriers or simply carriers, and one or more users 120AA-NN, such as mobile subscribers or consumers. The revenue generators 110A-N may pay the service provider 130 to display advertisements, such as on-line advertisements on a network such as a mobile network or the Internet. The payments may be based on various factors, such as the number of times an advertisement may be displayed to the users 120AA-NN and/or the number of times one of the users 120AA-NN may click through the advertisement to the revenue generator's web site or mobile site.

The service provider 130 may maintain a mobile site or mobile portal, such as a search site, where the service provider 130 may display advertisements of the revenue generators 110A-N to the users 120AA-NN. The service provider 130 may share revenue with the MNOs 115A-N for displaying advertisements of the revenue generators 110A-N on their mobile networks. Alternatively or in addition the service provider 130 may share revenue with individual mobile publishers for displaying advertisements of the revenue generators 110A-N on their mobile sites.

The users 120AA-NN may be consumers of goods or services who may be searching for a business such as the business of one of the revenue generators 110A-N. The users 120AA-NN may communicate with the service provider 130 through the mobile network operators 115A-N. The users 120AA-NN may supply information describing themselves to the service provider 130, such as the location, gender, or age of the users 120AA-NN, or generally any information that may be required for the users 120AA-NN to utilize the services provided by the service provider 130. Alternatively or in addition the service provider 130 may obtain information about the users 120AA-NN from the MNOs 115A-N.

In the system 100, the revenue generators 110A-N may interact with the service provider 130, such as via a web application. The revenue generators 110A-N may send information, such as billing, website or mobile site and advertisement information, to the service provider 130 via the web application. The web application may include a web browser or other application such as any application capable of displaying web content. The application may be implemented with a processor such as a personal computer, personal digital assistant, mobile phone, or any other machine capable of implementing a web application.

The users 120AA-NN may also interact individually with the service provider 130, through the mobile network operators 115A-N, such as via a mobile phone or any device capable of communicating with the mobile network operators 115A-N. The users 120AA-NN may interact with the service provider 130 via a mobile web-based application, a mobile standalone application, or any application capable of running on a mobile device. The service provider 130 may communicate data to the revenue generators 110A-N over a network and to the users 120AA-NN over a network via the MNOs 115A-N. The following examples may refer to a revenue generator A 110A as an online advertiser or mobile advertiser; however, the system 100 may apply to any revenue generators 110A-N who may desire to serve advertisements over mobile devices.

In operation, one of the revenue generators 110A-N, such as revenue generator A 110A, may provide information to the service provider 130. This information may relate to the transaction taking place between the revenue generator A 110A and the service provider 130, or may relate to an account the revenue A 110A generator maintains with the service provider 130. In the case of a revenue generator A 110A who is a mobile advertiser, the revenue generator A 110A may provide initial information necessary to open an account with the service provider 130.

A revenue generator A 110A who is an mobile advertiser may maintain one or more accounts with the service provider 130. For each account the revenue generator A 110A may maintain one or more campaigns. For each campaign the revenue generator A 110A may maintain one or more listings. A listing may include a search keyword and one or more carrier listings. Each carrier listing may identify the mobile carrier and may include an advertisement title, an advertisement description, a bid amount and a mobile site uniform resource locator (URL), if any. A carrier listing may represent an association between a search keyword, a mobile advertisement and a carrier whose users are targeted by the mobile advertisement.

The carrier listings may allow the service provider 130 to provide a mobile advertising marketplace separate from the web advertising marketplace, essentially separating the web keywords from the mobile keywords. The carrier listings may also allow the service provider 130 to provide a separate marketplace for each of the MNOs 115A-N, essentially separating the keywords associated with each of the MNOs 115A-N. For example, the revenue generator A 110A may place one bid on the keyword “dvd” for the MNO A 115A and a separate bid for the keyword “dvd” for the MNO B 115B. Furthermore, by creating a separate marketplace for each of the MNOs 115A-N, the revenue generator A 110A may create separate advertisements compatible with the underlying technology of each MNO.

The service provider 130 may implement the separation of keywords by utilizing a data field to indicate to which carrier a carrier listing may apply. For example, a revenue generator A 110A may have several listings for the same keyword; however, they may be differentiated by a data field indicating to which carrier each listing applies. Alternatively or in addition, if the database architecture does not support the addition of a separate field, or if the service provider 130 wishes to utilize the functionality of an existing web search marketing system, the keywords for each carrier may be separated by adding prefixes to the keywords. In this case, each of the carriers may be identified by a unique prefix identifier. The prefix identifier may include a combination of the geographical location of the carrier and a descriptor of the carrier. For example, the carrier SPRINT may have a prefix of “usmobsprintsb.”

The prefix may be separated from the keyword by a keyword separator, such as the character string “vxv.” The purpose of the keyword separator may be to identify the location in the character string where the prefix ends and the keyword begins. The “vxv” keyword separator may be particularly functional in this regard, because this sequence of letters may very rarely, or never, appear in the English language. Thus, the presence of the “vxv” character string may indicate the end of the prefix and the beginning of the keyword. For example, if the revenue generator A 110A bid on the keyword “dvd” for users on the carrier SPRINT, the keyword may be stored in an existing search marketing database as “usmobsprintsbvxvdvd.” The service provider 130 may later search for the advertisements associated with SPRINT for the keyword “dvd” by searching for the keyword “usmobsprintsbvxvdvd.”

If the revenue generator A 110A does not have a mobile site URL for the MNO A 115A, the revenue generator A 110A may still bid on a keyword for the MNO A 115A. In this case, the service provider 130 may dynamically create a “WAP ad.” The “WAP ad” may be an offer landing page containing the phone number of the advertiser and/or the logo of the advertiser. When a user AA 120AA clicks on the advertisement of the revenue generator A 110A who does not have a mobile site, the user AA 120AA may be taken to a page showing the phone number and/or logo of the revenue generator A 110A. The user AA 120AA may then use their mobile device to call the phone number of the revenue generator A 110A and complete their transaction. The data associated with the “WAP ad” may be stored in the advertisement title and/or the advertisement description fields.

The keywords may represent one or more search terms that the revenue generator A 110A wishes to associate with their advertisement. When a user AA 120AA searches for a search keyword via MNO A 115A, the mobile advertisement of the revenue generator A 110A may be displayed on the search results page. The service provider 130 may also implement directory search implementations, where the user AA 120AA may click through directories of families of related data. In this instance, the search keyword may be the name of the directory on which the user AA 120AA clicks. Alternatively or in addition the user AA 120AA may interact with the service provider 130 through an SMS search service.

For example, a revenue generator A 110A, such as GENERAL MOTORS, may desire to target a mobile advertisement for a GENERAL MOTORS JEEP to users 120AA-NA on MNO A 115A searching for the keywords “JEEP.” GENERAL MOTORS may place a bid with the service provider 130 for the keyword “JEEP” on MNO A 115A. The mobile advertisement of the revenue generator A 110A may be displayed when one of the users 120AA-NA on the MNO A 115A searches for the keyword “JEEP,” or clicks through a directory named “JEEP.” GENERAL MOTORS may be able to use the same interface to submit bids for “JEEP” on any of the MNOS 115A-N.

The advertisement title may represent the data the revenue generator A 110A wishes to be displayed to a user AA 120AA when the user AA 120AA searches for the keyword associated with the listing. Alternatively or in addition, the advertisement description may represent the data the revenue generator A 110A wishes to be displayed to a user AA 120AA when the user AA 120AA searches for the keyword associated with the listing. The mobile site URL may represent the link the revenue generator A 110A wishes a user AA 120AA to be directed to upon clicking on the mobile advertisement of the revenue generator A 110A, such as the home page of the revenue generator A 110A. The bid amount may represent a maximum amount the revenue generator A 110A may be willing to pay each time a user AA 120AA may click on the mobile advertisement of the revenue generator A 110A or each time the mobile advertisement of the revenue generator A 110A may be shown to a user AA 120AA.

There may be some instances where multiple revenue generators 110A-N may have bid on the same search keyword for the same MNO, such as MNO A 115A. The service provider 130 may serve to the users 120AA-NA the online advertisements on which the users 120AA-NA may be most likely to click. For example, the service provider 130 may include a relevancy assessment to determine the relevancy of the multiple mobile advertisements to the search keyword. The more relevant a mobile advertisement may be to the keyword the more likely it may be that the user AA 120AA may click on the advertisement. Methods for assessing relevancy in online web search marketing may also apply to mobile search marketing.

When one of the users 120AA-NN, such as the user AA 120AA, interacts with the service provider 130, such as by searching for a keyword, the service provider 130 may retain data describing the interaction with the user AA 120AA. The retained data may include the keyword searched for, the geographic location of the user AA 120AA, and the date/time the user AA 120AA interacted with the service provider 130. The data may also generally include any data available to the service provider 130 that may assist in describing the interaction with the user AA 120AA, or describing the user AA 120AA. The service provider 130 may also store data that indicates whether a mobile advertisement of one of the revenue generators 110A-N, such as the revenue generator A 110A, was displayed to the user AA 120AA, and whether the user AA 120AA clicked on the mobile advertisement.

The service provider 130 may already have information relating to the geographic location of the user AA 120AA and other information describing the user A 120A, such as gender, age, etc. This information may have been previously supplied to the service provider 130 by the user AA 120AA. Alternatively or in addition, the service provider 130 may obtain the location of the user AA 120AA based on the IP address of the user AA 120AA. The service provider 130 may use a current date/time stamp to store the date/time when the user AA 120AA interacted with the service provider 130. The service provider 130 may use any of the information describing the user or the keyword searched for by the user the relevancy of an advertisement to the search.

Furthermore, the service provider 130 may generate reports based on the data collected from the user interactions and communicate the reports to the revenue generators 110A-N to assist the revenue generators 110A-N in measuring the effectiveness of their mobile advertising. The reports may indicate the number of times the users 120AA-NN searched for the keywords bid on by the revenue generators 110A-N, the number of times a mobile advertisement of the revenue generators 110A-N was displayed to the users 120AA-NN, and the number of times the users 120AA-NN clicked through on the advertisements of the revenue generators 110A-N. There may be a separate report for each MNO 115A-N for which the revenue generator A 110A maintains a carrier listing. There may be a report displaying the aggregate data across all of the MNOs 115A-N for which the revenue generator A 110A maintains an carrier listing. The reports may also generally indicate any data that may assist the revenue generators 110A-N in measuring the effectiveness of their mobile advertising campaigns.

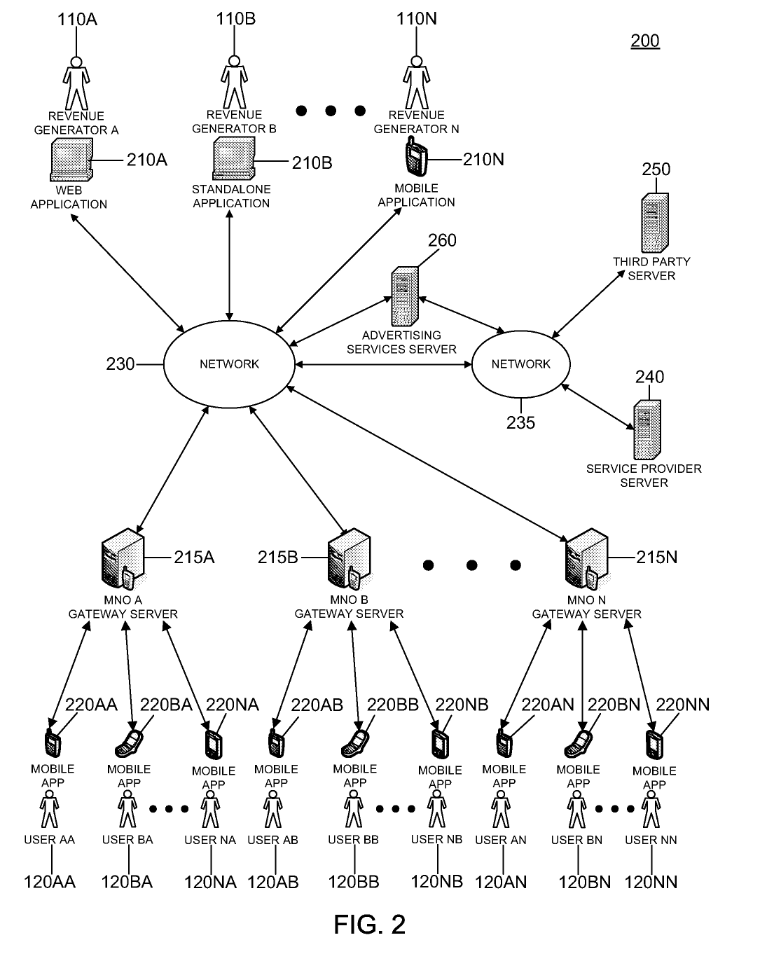

FIG. 2 provides a simplified view of a network environment implementing a system 200 for serving advertisements over mobile devices. Not all of the depicted components may be required, however, and some implementations may include additional components not shown in FIG. 2. Variations in the arrangement and type of the components may be made without departing from the spirit or scope of the disclosure. Additional, different or fewer components may be provided.

The system 200 may include one or more web applications, standalone applications and mobile applications 210A-N, which may be collectively or individually referred to as client applications of the revenue generators 110A-N. The system 200 may also include one or more mobile applications, or mobile applications 220AA-NN, which may collectively be referred to as client applications of the users 120AA-NN, or individually as a user client application. The system 200 may also include one or more MNO gateway servers 215A-N, a network 230, a network 235, the service provider server 240, a third party server 250, and an advertising services server 260.

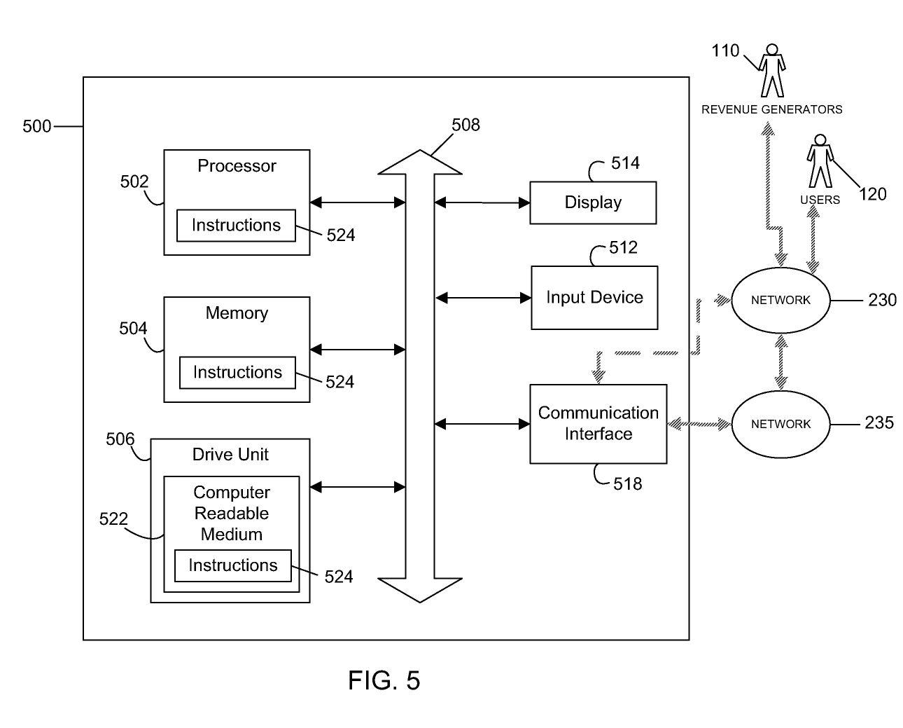

Some or all of the advertising services server 260, service provider server 240, and third-party server 250 may be in communication with each other by way of network 235 and may be the system or components described below in FIG. 5. The advertising services server 260, third-party server 250 and service provider server 240 may each represent multiple linked computing devices. Multiple distinct third party servers, such as the third-party server 250, may be included in the system 200. The third-party server 250 may be an MNO gateway server 215A-N or a server associated with, or in communication with an MNO gateway server 215A-N.

The networks 230, 235 may include wide area networks (WAN), such as the Internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The revenue generators 110A-N may use a web application 210A, standalone application 210B, or a mobile application 210N, or any combination thereof, to communicate to the service provider server 240, such as via the networks 230, 235. The service provider server 240 may communicate to the revenue generators 110A-N via the networks 230, 235 through the web applications, standalone applications or mobile applications 210A-N.

The users 120AA-NN may use a mobile application 220AA-220NN, such as a mobile web browser, to communicate with the service provider server 240 via the MNO gateway servers 215A-N and the networks 230, 235. The service provider server 240 may communicate to the users 120A-N via the networks 230, 235 and to the MNOs 215A-N through the mobile applications 220AA-NN.

The web applications, standalone applications and mobile applications 210A-N, 220AA-NN may be connected to the network 230 in any configuration that supports data transfer. This may include a data connection to the network 230 that may be wired or wireless. Any of the web applications, standalone applications and mobile applications 210A-N, 220AA-NN may individually be referred to as a client application. The web application 210A may run on any platform that supports web content, such as a web browser or a computer, a mobile phone, personal digital assistant (PDA), pager, network-enabled television, digital video recorder, such as TIVO® or a digital video recorder (DVR), automobile and/or any appliance capable of data communications.

The standalone applications 210B may run on a machine that may have a processor, memory, a display, a user interface and a communication interface. The processor may be operatively connected to the memory, display and the interfaces and may perform tasks at the request of the standalone applications 210B or the underlying operating system. The memory may be capable of storing data. The display may be operatively connected to the memory and the processor and may be capable of displaying information to the revenue generator B 110B. The user interface may be operatively connected to the memory, the processor, and the display and may be capable of interacting with a revenue generator A 110A. The communication interface may be operatively connected to the memory, and the processor, and may be capable of communicating through the networks 230, 235 with the service provider server 240, third party server 250 and advertising services server 260. The standalone applications 210B may be programmed in any programming language that supports communication protocols. These languages may include: SUN JAVA, C++, C#, ASP, SUN JAVASCRIPT, asynchronous SUN JAVASCRIPT, or ADOBE FLASH ACTIONSCRIPT, amongst others.

The mobile applications 210N, 220AA-NN may run on any mobile device which may have a data connection. The mobile applications 210N, 220AA-NN may be a web application 210A, a standalone application 210B, or a mobile browser. The mobile device may be one of a broad range of electronic devices which may include mobile phones, PDAs, and laptops and notebook computers. The mobile device may have a reduced feature set, such as a smaller keyboard and/or screen, and may be incapable of supporting a traditional web search.

The data connection of the mobile device may be a cellular connection, such as a GSM/GPRS/WCDMA connection, a wireless data connection, an Internet connection, an infra-red connection, a Bluetooth connection, or any other connection capable of transmitting data. The data connection may be used to connect directly to the network 230, or to connect to the network 230 through the MNO gateway servers 215A-N. The MNO gateway servers 215A-N may control the access that the mobile applications 210AA-NN may have to the network. The MNO gateway servers 215A-N may also control the technology supporting the respective mobile applications 220AA-NN. This may affect all aspects of the user experience, such as signal strength and availability, speed and billing mechanisms. For example, the MNO gateway server A 215A may only allow the users 120AA-NA access to content provided by partners of the MNO A 115A. Furthermore, the MNO gateway servers 215A-N may only allow users 120AA-NN access to data in a specific format, such as WML, XHTML, NTT DOCOMO IMODE HTML, or cHTML. Alternatively or in addition, the mobile applications 220AA-NN may only support one of the aforementioned formats.

The service provider server 240 may include one or more of the following: an application server, a data source, such as a database server, a middleware server, and an advertising services server. One middleware server may be a mobile commerce platform, such as the YAHOO! SUSHI platform, which may properly encode data, such as mobile pages or mobile advertisements, to the formats specific to the MNO gateway servers 215A-N. The service provider server 240 may co-exist on one machine or may be running in a distributed configuration on one or more machines. The service provider server 240 may collectively be referred to as the server. The service provider server 240 may receive requests from the users 120AA-NN and the revenue generators 110A-N and may serve mobile pages to the users 120AA-NN and web pages and/or mobile pages to the revenue generators 110A-N based on their requests.

The third party server 250 may include one or more of the following: an application server, a data source, such as a database server, a middleware server, and an advertising services server. The third party server 250 may co-exist on one machine or may be running in a distributed configuration on one or more machines. The advertising services server 260 may provide a platform for the inclusion of advertisements in pages, such as web pages or mobile pages. The advertising services server 260 may be used for providing mobile advertisements that may be displayed to the users 120AA-NN.

The service provider server 240, the third party server 250 and the advertising services server 260 may be one or more computing devices of various kinds, such as the computing device in FIG. 5. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 210A may employ HTTP to request information, such as a web page, from a web server, which may be a process executing on the service provider server 240 or the third-party server 250.

There may be several configurations of database servers, application servers, middleware servers and advertising services servers included in the service provider server 240 or the third party server 250. Database servers may include MICROSOFT SQL SERVER, ORACLE, IBM DB2 or any other database software, relational or otherwise. The application server may be APACHE TOMCAT, MICROSOFT IIS, ADOBE COLDFUSION, YAPACHE or any other application server that supports communication protocols. The middleware server may be any middleware that connects software components or applications. The application server on the service provider server 240 or the third party server 250 may serve pages, such as web pages to the users 120A-N and the revenue generators 110A-N. The advertising services server 260 may provide a platform for the inclusion of advertisements in pages, such as web pages. The advertising services server 260 may also exist independent of the service provider and the third party servers 240, 250.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

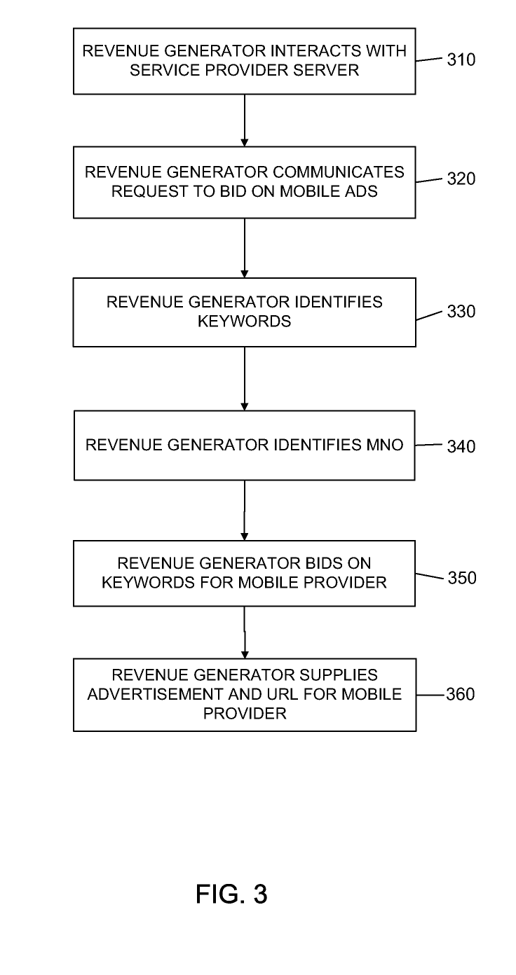

FIG. 3 is a flowchart illustrating steps that may be taken by one of the revenue generators 110A-N in the systems of FIG. 1, and FIG. 2, or other systems for serving advertisements over mobile devices. The steps may occur when one of the revenue generators 110A-N, such as the revenue generator A 110A, wishes to bid on keywords for a carrier, such as the MNO A 115A. At block 310, the revenue generator A 110A interacts with the service provider server 240, such as by logging onto the service provider 130. At block 320, the revenue generator A 110A may communicate a request to bid on mobile keywords.

At block 330, the revenue generator A 110A may communicate information identifying the keyword the revenue generator A 110A wishes to bid on. At block 340, the revenue generator A 110A may identify one or more MNOs 115A-N, such as the MNO A 115A, that the revenue generator A 110A wishes to bid for the keyword on. Once the revenue generator A 110A identifies one or more MNOs 115A-N, the system 100 may move to block 350. At block 350, the revenue generator A 110A may place a bid on the identified keyword for the MNO A 115A. The bid made by the revenue generator A 110A may only apply to the keyword when searched for on the MNO A 115A. The revenue generator A 110A may specify one or more other MNOs 115B-N which the bid may apply to.

At block 360, the revenue generator A 110A may communicate to the service provider 130 a mobile advertisement and a mobile URL to which the advertisement may link. The mobile advertisement may consist of a description of the advertisement and/or a title of the advertisement. The limited space available on the screens of mobile devices may necessitate that a mobile advertisement be relatively shorter than a web advertisement. Alternatively or in addition, the advertisement may include other elements, such as images, audio, and/or video elements (together “creatives”). If the revenue generator A 110A does not have a mobile URL for the MNO A 115A, the service provider 130 may generate a “WAP ad” for the revenue generator A 110A. The “WAP ad” may be a mobile page for the MNO that contains the phone number and/or the logo of the revenue generator A 110A. The “WAP ad” data may be stored in the advertisement description field of the MNO listing of the revenue generator A 110A.

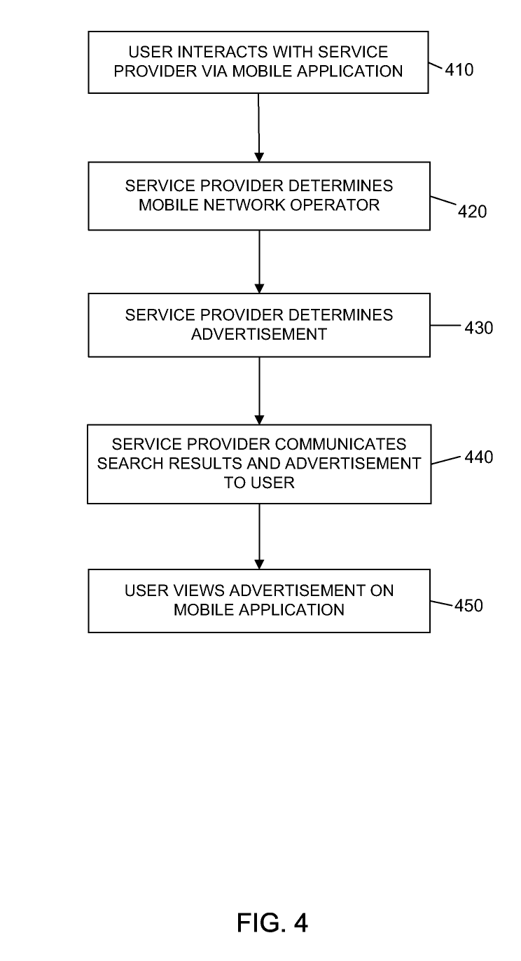

FIG. 4 is a flowchart illustrating steps that may be taken by one of the users 120AA-NN in the systems of FIG.1, and FIG. 2, or other systems for serving advertisements over mobile devices. The steps may occur when one of the users 120AA-NN, such as the user AA 120AA, performs a search on a mobile application 220AA-NN via a MNO 115A-N, such as the MNO A 115A. At block 410, the user AA 120AA may interact with the service provider 130 via the mobile application AA 220AA, such as by performing a search from the mobile application AA 220AA. At block 420, the service provider 130 may determine the carrier the request of the user AA 120AA originates from, such as the MNO A 115A. At block 430, the service provider 130 may determine which advertisements may relate to the keyword searched for on the MNO A 115A. The service provider 130 may select advertisements from revenue generators 110A-N who may have bid on the keyword searched for from the MNO A 115A. The service provider 130 may select the revenue generator A 110A with the highest bid for the keyword from the MNO A 115A. Alternatively or in addition the service provider 130 may select more than one advertisement to display to the user AA 120AA. The size of the screen on the device of the user AA 120AA may be a factor used in determining how many advertisements to communicate to the user AA 120AA.

At block 440, the service provider 130 may communicate the advertisement and search results to the user AA 120AA via the MNO A 115A and the mobile application AA 220AA. At block 450, the user AA 120AA may view the search results and accompanying advertisement via the mobile application AA 220AA.

FIG. 5 is an illustration of a general computer system 500 that may be used in a system for content filtering advertisements before approval of service of the advertisements through a publisher (or service provider) to a mobile device. The general computer system 500 may represent a service provider server 240, a third party server 250, an advertising services server 260, a mobile device or any of the other computing devices referenced herein. The computer system 500 may include a set of instructions 524 that may be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 524 (sequential or otherwise) that specify actions to be taken by that machine. In a particular embodiment, the computer system 500 may be implemented using electronic devices that provide voice, video or data communication. Further, while a single computer system 500 may be illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, such as, a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 504 may include a cache or random access memory for the processor 502. Alternatively or in addition, the memory 504 may be separate from the processor 502, such as a cache memory of a processor, the system memory, or other memory.

The memory 504 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 504 may be operable to store instructions 524 executable by the processor 502. The functions, acts or tasks illustrated in the Figures or described herein may be performed by the programmed processor 502 executing the instructions 524 stored in the memory 504. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 500 may further include a display 514, such as a liquid crystal display (LCD), an organic light emitting diode (OLED), a flat panel display, a solid state display, a cathode ray tube (CRT), a projector, a printer or other now known or later developed display device for outputting determined information. The display 514 may act as an interface for the user to see the functioning of the processor 502, or specifically as an interface with the software stored in the memory 504 or in the drive unit 506.

Additionally, the computer system 500 may include an input device 512 configured to allow a user to interact with any of the components of the system 500. The input device 512 may be a number pad, a keyboard, or a cursor control device, such as a mouse, or a joystick, touch screen display, remote control or any other device operative to interact with the system 500.

The computer system 500 may also include a disk or optical drive unit 506. The disk drive unit 506 may include a computer-readable medium 522 in which one or more sets of instructions 524, e.g. software, can be embedded. Further, the instructions 524 may perform one or more of the methods or logic as described herein. The instructions 524 may reside completely, or at least partially, within the memory 504 and/or within the processor 502 during execution by the computer system 500. The memory 504 and the processor 502 also may include computer-readable media as discussed above.

The present disclosure contemplates a computer-readable medium 522 that includes instructions 524 or receives and executes instructions 524 responsive to a propagated signal; so that a device connected to a network 230 or a network 235 may communicate voice, video, audio, images or any other data over the networks 230, 235 (together “network 235”). The instructions 524 may be implemented with hardware, software and/or firmware, or any combination thereof. Further, the instructions 524 may be transmitted or received over the network 235 via a communication interface 518.

The communication interface 518 may be a part of the processor 502 or may be a separate component. The communication interface 518 may be created in software or may be a physical connection in hardware. The communication interface 518 may be configured to connect with a network 235, external media, the display 514, or any other components in the system 500, or combinations thereof. The connection with the network 235 may be a physical connection, such as a wired Ethernet connection or may be established wirelessly as discussed below. Likewise, the additional connections with other components of the system 500 may be physical connections or may be established wirelessly. In the case of a service provider server 240, a third party server 250, or an advertising services server 260, the servers may communicate with users 120A-N and the revenue generators 110A-N through the communication interface 518.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 522 may be a single medium, or the computer-readable medium 522 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 522 may include a solid-state memory such as a memory card or other package that houses one or more non-volatile read-only memories. The computer-readable medium 522 also may be a random access memory or other volatile re-writable memory. Additionally, the computer-readable medium 522 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

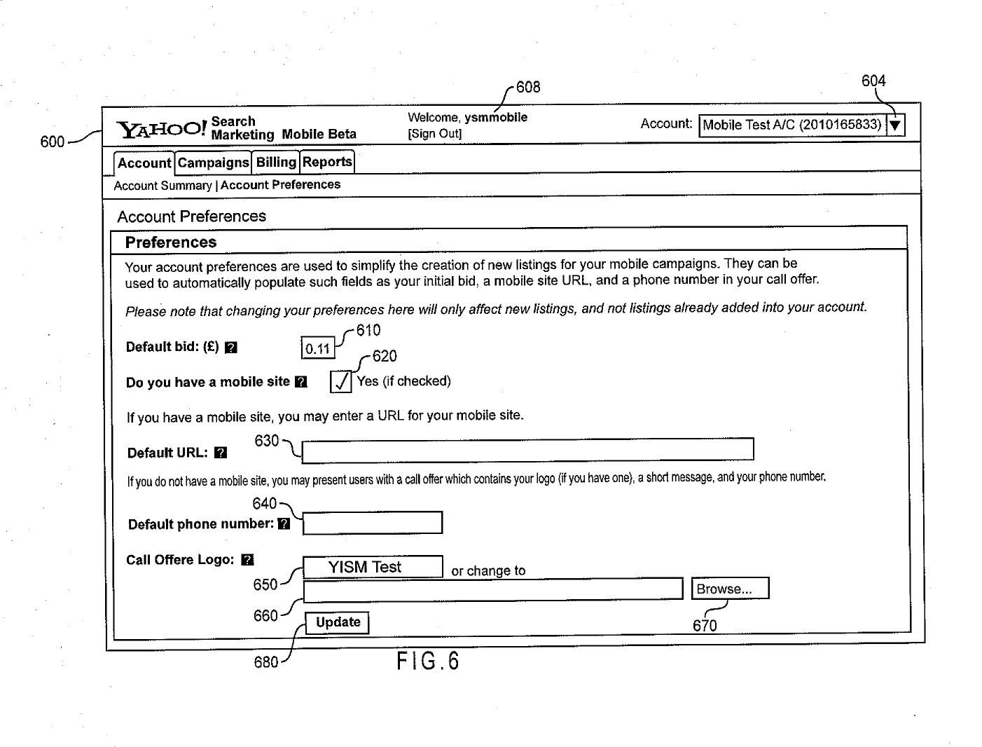

FIGS. 6, 7, and 8 all show screen shots that together comprise an advertiser user interface for the revenue generators 110A-N to access to set up an account, set preferences, manage advertising campaigns and affiliated bids, and track editorial statuses of advertisement listings across one or more campaigns. The screen shots may be representations of a webpage that may be presented to an advertiser for review or update through, for instance, an internet browser of a personal computer or other communicating device as discussed herein. As advertisement listings may be carrier-specific, it will be explained how the ability to manage advertisement listings of such campaigns may be according to mobile carrier. The editorial process is also made to be mobile carrier-specific and may need to be customized according to specific carriers to which the advertisements will be delivered for service to mobile devices.

FIG. 6 is a screenshot of an implementation of a revenue generator account preferences view of a revenue generator interface in the systems of FIG. 1 and FIG. 2 or any other system serving advertisements over mobile devices. A revenue generator interface may be displayed to one of the revenue generators 110A-N, such as the revenue generator A 110A, when the revenue generator A 110A interacts with the service provider 130. The account preferences screen may allow the revenue generator A 110A to view or change default settings for the selected account. The screenshot 600 may include an account drop-down box 604, a revenue generator identifier 608, a default bid textbox 610, a mobile site checkbox 620, a default URL textbox 630, a default phone number textbox 640, a logo display 650, a logo textbox 660, a browse button 670 and an update button 680.

The revenue generator A 120A may enter a default bid amount in the default bid textbox 610. The revenue generator A 110A may check the mobile site checkbox 620 if the revenue generator A 110A has a mobile site. If the revenue generator A 110A has a mobile site, the revenue generator A 110A may enter the URL of the mobile site in the default URL textbox 630.

If the revenue generator A 110A does not have a mobile site, the service provider 130 may generate a “WAP ad” for the revenue generator A 110A. The “WAP ad” may include the phone number and logo of the revenue generator A 110A and a short message. The revenue generator A 110A may supply their phone number in the default phone number box 640. The revenue generator A 110A may specify the location of their logo in the logo textbox 660. Alternatively or in addition the revenue generator A 110A may browse for their logo by clicking on the browse button 670. A preview of the logo may be displayed in the logo display 650. The revenue generator A 110A may submit the changes to the service provider 130 by clicking on the update button 680.

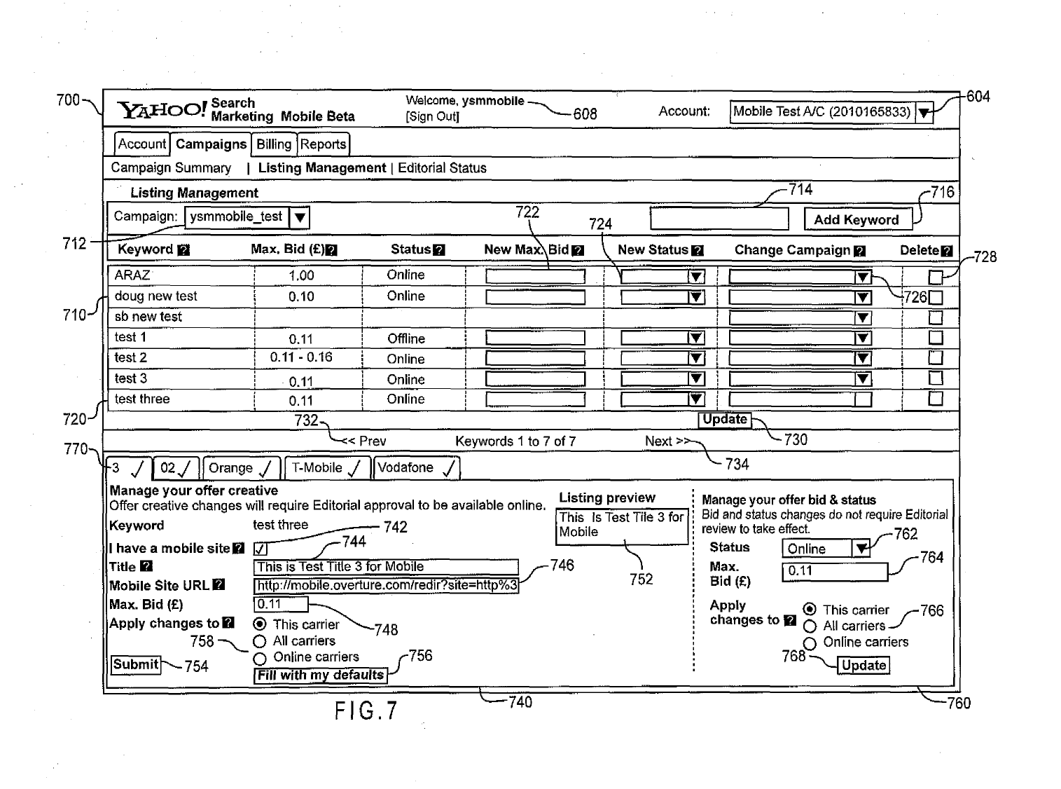

FIG. 7 is a screenshot 700 of an implementation of a revenue generator listing management view of a revenue generator interface in the systems of FIG. 1 and FIG. 2 or any other system serving advertisements over mobile devices. A revenue generator interface may be displayed to one of the revenue generators 110A-N, such as the revenue generator A 110A, when the revenue generator A 110A interacts with the service provider 130. The listing interface screen may allow the revenue generator A 110A to add/modify/view their listings, and their carrier listings. The screenshot 700 may include a listing summary table 710, a manage creative table 740, a manage offer table 760, an account drop-down box 740, and a revenue generator identifier 750.

The listing summary table 710 may include a campaign drop-down box 712, an add keyword textbox 714, an add keyword button 716, an update listings button 730, a previous listings link 732, a next listings link 734 and one or more rows of keyword data. The rows of keyword data may include a keyword link 720, a maximum bid, a status, a new maximum bid textbox 722, a new status drop-down box 724, a change campaign drop-down box 726, and a delete keyword checkbox 728.

The manage creative table 740 may include carrier tabs 770, a mobile site checkbox 742, a listing title textbox 744, a mobile site URL textbox 746, a maximum bid textbox 748, apply changes radio buttons 758, a listing preview window 752, a submit button 754, and a defaults button 756. The manage offer table 760 may include a status drop-down box 762, a maximum bid textbox 764, an apply changes radio buttons 766, and an update offer button 768.

The listing summary table 710 may display all of the listings of the campaign identified by the campaign drop-down box 712. The campaign drop-down box may allow the revenue generator A 110A to choose one of the campaigns associated with the account identified in the account drop-down box 604. The account drop-down box 604 may include all of the accounts associated with the revenue generator A 110A. The summary listing table 710 may contain a row of data for each listing of the campaign. The data may include the keyword associated with the listing, the maximum bid of the listing, and the status of the listing. The revenue generator A 110A may be able to enter a new maximum bid for the keyword in the new maximum bid textbox 722. The status of the keyword may be modified by changing the new status drop-down box 724. The campaign the listing is associated with may be modified by the change campaign drop-down box 726. The listing may be deleted by clicking on the delete checkbox 728. The revenue generator A 110A may submit the changes by clicking on the update listings button 730. The previous listings link 732 and the next listings link 734, may allow the revenue generator A 110A to view other listings associated with the selected campaign.

The revenue generator A 110A may be able to click on the keyword link 720 to change the data related to the carrier listings of the keyword. When the revenue generator A 110A clicks on a keyword link 720, the manage creative table 740 and the manage offer table 760 may update to reflect the data associated with the keyword link 720 clicked on. The carrier listings data may be modified in the manage creative table 740 and the manage offer table 760. The manage creative table 740 may allow the revenue generator A 110A to modify the advertisement associated with each carrier listing for the keyword. The revenue generator A 110A may be able to view data associated with each of the carrier listings by clicking through the carrier tabs 770.

The manage creative table 740 may display the keyword the revenue generator A 110A is currently viewing. The revenue generator A 110A may identify whether they have a mobile site for the carrier by clicking on the mobile site checkbox 742. If the revenue generator A 110A has a mobile site for the carrier identified by the carrier tabs 770, the revenue generator A 110A may enter the title of the advertisement in the listing title textbox 744. The listing title may be the text of the advertisement that may be displayed to the users 120AA-NN. The revenue generator A 110A may enter the URL of their mobile site for the carrier in the mobile site URL textbox 746. The mobile site URL may be the URL that the users 120AA-NN may be directed to upon clicking on the advertisement of the revenue generator A 110A. The revenue generator A 110A may identify their maximum bid for the keyword on the carrier in the maximum bid textbox 748. The maximum bid may identify the maximum amount the revenue generator A 110A may be willing to pay to have their advertisement displayed to users 120AA-NN of the carrier. The apply changes radio buttons 758 may allow the revenue generator A 110A to specify which carriers the changes may apply to. The revenue generator A 110A may submit the changes by clicking on the submit button 754.

The revenue generator A 110A may click on the defaults button 756 to fill the data fields in the manage creative table 740 with any defaults they identified in the account preferences screenshot 900. A preview of the advertisement may be displayed in the listing preview window 752. If the revenue generator A 110A makes changes to the manage creative table 740, the revenue generator A 110A may need editorial approval. Editorial approval may require a supervisor or account administrator of the service provider 130 to approve of the creative changes to the listing for the given carrier. The editorial approval process, which will be discussed in detail below, may ensure that the advertisement does not contain hate terms, infringe on others' trademarks, or otherwise be inappropriate for displaying to the users 120AA-NN. Alternatively or in addition the editorial approval may be automated and may be performed by the service provider 130.

The manage offer table 760 may allow the revenue generator A 110A to modify a subset of the data associated with the carrier listing that does not require editorial approval. The revenue generator A 110A may change the status of the carrier listing by clicking on the status drop-down box 762. The revenue generator A 110A may modify the bid amount in the maximum bid textbox 764. The revenue generator A 110A may select which carriers the changes may apply to by using the apply changes radio buttons 766. The revenue generator A 110A may update the manage offer table 760 information by clicking on the update offer button 768.

Alternatively or in addition the service provider 130 and/or the revenue generators 110A-N may use middleware to implement a presentation abstraction layer, such as the YAHOO! MOBILE SUSHI platform, to simplify the process of creating campaigns across multiple MNOs 115A-N.

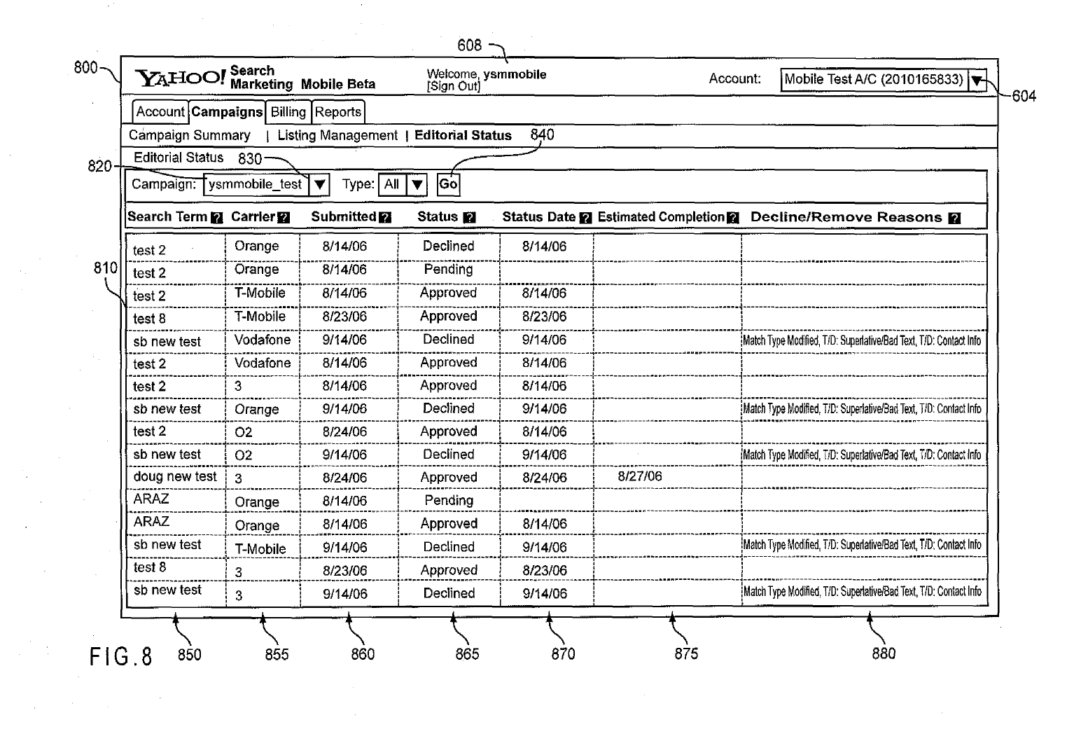

FIG. 8 is a screenshot 800 of an implementation of a revenue generator editorial status view of a revenue generator interface in the systems of FIG. 1 and FIG. 2 or any other system serving advertisements over mobile devices. A revenue generator interface may be displayed to one of the revenue generators 110A-N, such as the revenue generator A 110A, when the revenue generator A 110A interacts with the service provider 130. The editorial status screen may allow the revenue generator A 110A to view the editorial status of their listings. The screenshot 800 may include an editorial status table 810, a campaign drop-down box 820, a type drop-down box 830, a go button 840, an account drop-down box 604, and a revenue generator identifier 608.

The editorial status table 810 may display the editorial status of the listings associated with the campaign identified in the campaign status drop-down box 820. The listing data may be further filtered by selecting a status type of the listing in the type drop-down box 830, such as “All,” “Declined,” “Pending,” or “Approved.” The editorial status table 810 may include a plurality of columns including a keyword column 850, a carrier column 855, a date submitted column 860, a status column 865, a status date column 870, an estimated completion date column 875, and a column 880 to detail the reason or reasons for declining or removing an advertisement. The status type in the type drop-down box 830 may refer to the status displayed in the status column 865 in the editorial status table 810.

The keyword column 850 may include a list of keywords associated with a mobile advertisement listing, thus each row corresponds to a unique keyword for a given carrier. The carrier column 855 may include various mobile device carriers associated with the keywords. The date submitted column 860 may be the date on which a mobile advertisement listing may have been submitted for editorial review for a particular carrier. The status column 865 may include information about whether a keyword may have been approved for use as a keyword for a mobile advertisement listing for a particular carrier. For example, the status column 865 may indicate that the keyword may have been declined, may be pending review, or that the keyword may have been approved. Information in the status column may correspond to information entered by the editor via an editor user interface (not shown).

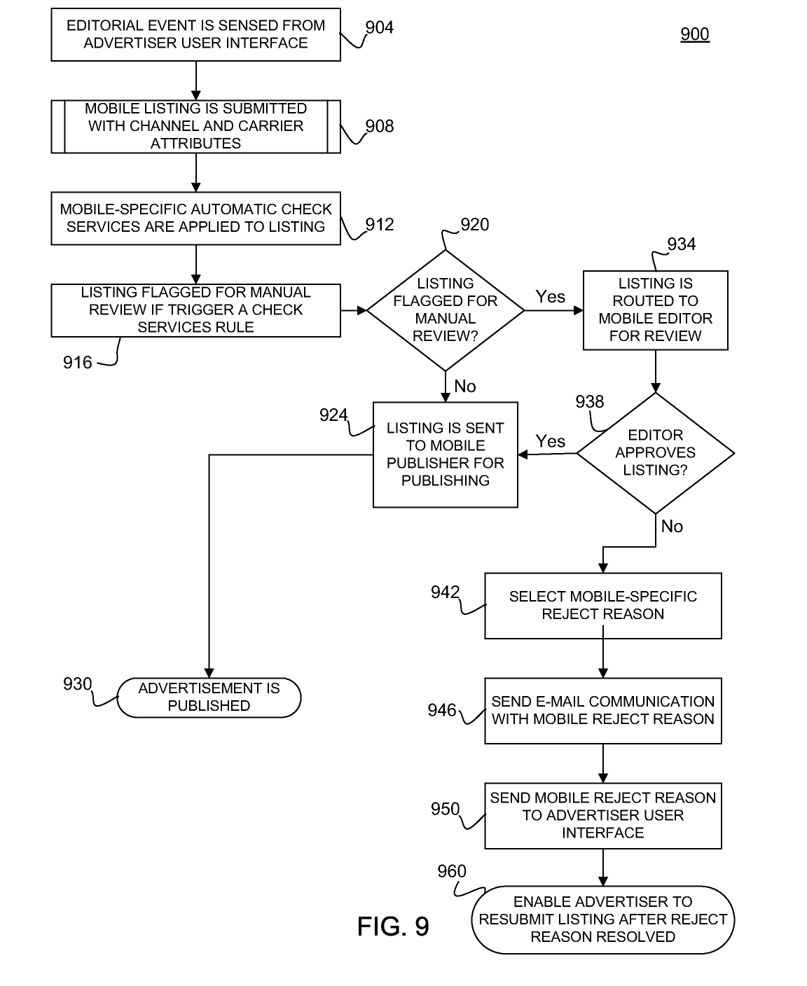

The estimated completion column 875 may provide a date upon which editorial review of a keyword and its listing may be completed. The column giving the reasons for declining a keyword 880 may provide a more detailed reason of why a keyword may have been rejected. This information may correspond to information provided by the editor via the editor user interface. A keyword term may be rejected, for example, because a keyword may have been a duplicate keyword. In other words, the keyword may have already been associated with a particular mobile advertisement listing for the particular carrier. If this is the case, the advertiser may not want the duplicate term because this may result in an increased fee for a word that adds no value. Another reason for rejecting a term may, for example, be because the mobile advertisement listing uses bad text. It is to be appreciated that there may be numerous reasons for rejecting keywords and the reasons given above are only exemplary. Other reasons relate to filtering out listings based on advertisement content, which will be discussed with reference to FIG. 9.

The revenue generator A 110A may submit changes to the campaign drop-down box 820 or the type drop-down box 830, by clicking on the go button 840. Clicking on the go button 840 may refresh the editorial status table 810 with data filtered by the selected campaign and type.

FIG. 9 is a flow chart 900 of a method for content filtering advertisements before approval of service of the advertisements through a publisher (or service provider) to one or more mobile devices. At block 904, an editorial event is sensed from the advertiser (or revenue generator) user interface referenced above (FIGS. 6, 7, and 8 or through other pages available to the advertiser not disclosed herein). This event may include, but is not limited to, the creation or modification of mobile sponsored advertisement listings (“mobile listings”), the addition of keywords, creating or editing advertisements affiliated with the mobile listings, and submitting/modifying keyword-level URL overrides. A URL override is specific to a keyword, and refers to the capability to ignore the URL submitted with an advertisement listing, and instead use the “override” URL. Finally, an editorial event may include adding a carrier to an existing mobile listing because aspects of editorial review are carrier-specific. An editorial event may be an event that triggers review of a mobile advertisement listing.

At block 908, the system 500 enables submission of the mobile advertisement listing with one or more channel and carrier attributes. The mobile listing that is submitted is routed to a mobile-only queue so that the rest of the method is executed on listings destined for mobile devices. At block 912, a mobile carrier-specific automatic check is applied to the mobile listing, including at least one automatic check service. The automatic check services may include, but are not limited to, a format check, a risk terms check, and a market-specific terms list check, each of which will be expanded on below. A mobile listing that moves beyond block 912 may comply with the various rules (or criteria) applied to the listing by the automatic check services, and therefore moves onto block 920 (but see discussion of an exception, below). At block 916, however, a listing that has triggered one of the check services rules or otherwise matched up with a format or terms check, as discussed above, is flagged for manual review.

At block 920, the system 500 determines whether the advertisement listing has been flagged for manual review. If the answer is no, at block 924, the mobile advertisement listing is sent to a mobile publisher's server to be served with web page content when published to a mobile device. As discussed previously, the server may be in relation the service provider 130, and therefore may include the service provider server 240, the third party server 250, or the advertising services server 260 or some other mobile publisher. At block 930, the advertisement, as approved with its listing, is published for access by the users 120.

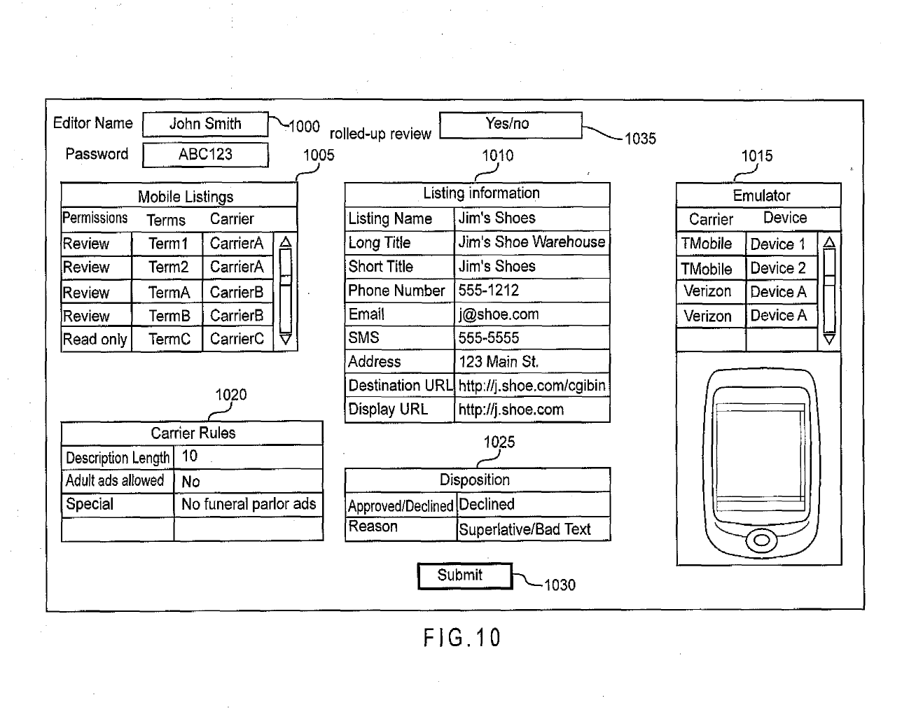

If the answer to the inquiry of block 920 is yes, than at block 934 the mobile listing is routed to a mobile editor for manual review. The parameters of such reviews will be discussed in more detail below, and a graphical user interface (GUI) that may be accessed by the mobile editor to conduct such review is shown in FIG. 10. At block 938, the system 500 determines if the mobile editor approves the mobile listing. If the mobile listing is approved, than the mobile listing is sent to block 924 for service during publishing by the mobile publisher. If, however, the advertisement listing is disapproved at block 938, at block 942 a mobile carrier-specific reject reason is selected. At block 946, the carrier-specific reject reason is sent via e-mail (or some other preferred means such as text messaging) to the advertiser. At block 950, the carrier-specific reject reason is sent to the advertiser user interface for display to the advertiser.

Finally, at block 960, the system 500 enables the advertiser to resubmit the mobile advertisement listing once the mobile carrier-specific reject reason is resolved. Persistent check services (PCS) may be employed after an advertisement listing has been rejected. PCS may be designed to identify a mobile listing that has been resubmitted and show the old reject reason associated with that listing. A resubmitted mobile listing, after appropriate editing or modification in light of the carrier-specific reject reason, may be required to be available to human editors that can consider the changes and approve the modified mobile listing if the original reject reasons are resolved and there appears to be no other reasons for declining the mobile listing.

The following is a more detailed discussion of various aspects of the method discussed in FIG. 9. At block 908, a mobile advertisement listing along with carrier attributes may be submitted into the editorial process. Carrier attributes may, for example, include the name of the carrier. In some implementations, the mobile advertisement listings may be routed to a mobile-only queue for editorial review instead of routing the mobile advertisement listing to a generalized reviewing queue. For example, advertisement listings not targeting mobile devices may be routed to the generalized queue for review while advertisement listings such as mobile advertisement listings that target mobile devices may be routed to a queue that may only include mobile advertisement listings directed towards mobile devices.

At block 912, a mobile carrier-specific automatic check may be performed. This may be accomplished by checking a mobile advertisement listing against several databases. For example, the mobile advertisement listing may be checked against a risk data set, which may be utilized to scan for words (or creatives) related to adult themes, gambling, blocked content from a partner block list, suspect text, trademarks, or prescription drug terms, etc. The mobile advertisement listing may also be checked against a format dataset, which may be utilized to check parameters such as field length (such as for the title or advertising copy), font type and size, etc. In some implementations, the format dataset may include carrier-specific data. The mobile specific data may be necessary because different mobile devices may have different formatting requirements. For example, the screen size on various mobile devices may be different. A mobile device with a larger screen may be able to display a longer mobile advertisement listing than a mobile device with the smaller screen.

The mobile advertisement listing may also be checked against a dataset including mobile carrier-specific and market-specific terms. The market-specific terms list check compares terms (or creatives) with a carrier-specific dataset for each of a plurality of geographic markets (e.g., U.S., U.K., Japan). The check services may also include rules that aid in comparison of the datasets. The mobile carrier-specific terms list for each market may be built and maintained by the service provider 130 with help from in-market teams. The carrier-specific terms list may further be divided or organized according to mobile carriers. Carrier-specific handling of filtering is discussed below.

In some implementations, it may not be necessary to review a mobile advertisement listing where the mobile advertisement listing has a low monetary value or where the mobile advertisement listing utilizes low volume terms, e.g., to reduce costs affiliated with the manual review process. In such cases, the mobile listing may not get flagged for manual review process at block 916. If not flagged, these mobile listings may automatically be published, in which case there exists a risk that some mobile listing may have a bad (or broken) URL. To prevent a mobile advertisement listing with a bad URL from being published, a mobile-site crawl tool may be utilized to verify that the URL works.

The mobile site crawl tool that automatically filters the mobile websites may not catch websites with bad URL's. These types of listings that sneak through the mobile listings filtering process may be cleaned or taken down, e.g. removed, with a scrub process by a research and quality control console (RQCC) (not shown). When the term “clean” is used, it is with regards to modifying the URL on some mobile devices for function or aesthetic reasons. There exists a limit on the number of characters available for expressing the URL, especially on mobile devices, which may require modification. There is also sometimes a desire to remove the long variable string that may exist at the end of a URL, such as a session identification or an affiliate website extension.

The RQCC is also applicable to regular Web advertisement listings and may apply to all carriers in terms of mobile listings. That is, if a decision is made to take down the mobile listing due to parameters of the RQCC scrub process, the mobile listing will be taken down for all carriers associated with that mobile listing. In addition to the scrub process of the RQCC, style cleaning rules such that are used to clean URLs related to regular Web sponsored search listings may also be available to clean mobile advertisement listings.

When a mobile listing is routed to a mobile editor for review at block 934, the mobile editor that receives the mobile listing necessarily has permission to conduct such review, or the mobile editor has the ability to assign the mobile listing to other editors who do have such permissions. Mobile editors are able to perform an atomic review of terms, creatives, and URLs as well as a relationship review. Relationship review refers to a manual review of the three components of an advertisement—the keyword, the title and description, and the URL—to gauge relevance amongst each other.

Mobile listings may be reviewed through the process of FIG. 9 specifically for each carrier associated with the mobile listing. In some implementations, mobile editors may set their preference of carrier, or may be willing and able to review the mobile listings for all carriers associated with mobile listings. For instance, editors in Japan often perform carrier-specific reviews for new mobile listings, whereas editors in the U.S. may review a “rolled-up” listing, or a single instance of the listing with multiple, specified carriers. Alternatively, the editor may prefer to do a carrier specific review. Choice between doing a rolled-up and a carrier-specific review is discussed further with reference to FIG. 10.

In some embodiments, the mobile editors are able to assign a carrier-specific editorial status, e.g., be able to approve a mobile listing for a carrier, while rejecting the same listing for another carrier. In other words, the rejection may specify that the mobile advertisement listing may not be approved for a first carrier, but reject the mobile advertisement listing for a second carrier.

If a mobile advertisement listing is rejected, then at blocks 946 and 950, the reason for the rejection may be communicated to the advertiser. For instance, editorial statuses may be displayed on the user interface in the editorial status table 810 at the carrier level (FIG. 8) or in another screen or webpage available for viewing by the advertiser. E-mail or text message communication may also be used as redundant forms of communication of such statuses to an advertiser. Such e-mail or text communication may contain a link that, when selected, directs a browser to the screen or webpage displaying the editorial status.

A variety of content development tools are also made available to help advertisers build mobile advertisement listings. Carrier-specific guidelines such as restrictions on certain terms/advertisements that are not acceptable to certain carriers may be enforced via a partner block list. The partner block list includes an amalgam of blocked terms from various carriers, which is enforceable by carrier-specific filtering discussed above.

Another content development tool includes a bulk-sheet template that is available for content development by advertisers and agencies that can download the tool in order to upload mobile sponsored search (MSS) campaigns having multiple listings. The bulk-sheet template allows carrier-selection, carrier-specific bidding, and upload of creatives. The bulk-sheet template may communicate through the user interface (FIGS. 6, 7, and 8). This bulk-sheet template may be specific to MSS campaigns and may not work with Web-sponsored search campaigns.

FIG. 10 depicts a user interface with a group of editorial graphical user interface (GUI) elements that may be utilized by an editor to review a mobile advertisement listing. These elements are exemplary only and other may be used as guided by the method of FIG. 9. Shown in FIG. 10 are fields for an editor's name and password 1000, a mobile advertisement listing review list box 1005, listing information fields 1010, a mobile device emulator 1015, a carrier rules list box 1020, a disposition list box 1025, a submit button 1030, and a “rolled-up” review selection box 1035. The GUI elements shown in FIG. 10 may be shown on a webpage that may be presented to an editor so that the editor may review mobile advertisement listings and submit status information via an internet browser.

The fields for an editor's name and password 1000 may be utilized to authenticate the editor with the system. In some implementations, editors are authenticated so that all editors do not have access to all the mobile advertisement listings. The mobile advertisement listing review list box 1005 may provide information to the editor related to the number of mobile advertisement listing submissions that may need processing. The mobile advertisement listing review list box 1005 may comprise information related to keyword terms and carriers. The mobile advertisement listing review list box 1005 may also indicate which mobile advertisement listings are reviewable by the authenticated editor. Mobile advertisement listings that may not be reviewed by the authenticated editor may, for example, be grayed out, where advertisement listings that are reviewable by the authenticated editor may be selectable.

The “rolled-up” review selection box 1035, may allow the editor to specify the way in which the editor may choose to review listings. For example, one editor may prefer to do a “rolled-up” review. This may result in the mobile advertisement listing review list box 1005 being sorted based on advertisement listings so that the editor may concentrate on an advertisement listing as it relates to various carriers. Alternatively, the editor may prefer to do a carrier-specific review. This may result in the mobile advertisement listing review list box 1005 being sorted based on the carrier so that the editor may concentrate on a specific carrier.

The listing information fields 1010 may provide mobile advertisement listing information related to one or more items selected in the mobile advertisement listing review list box 1005. The listing information fields 1010 may include, for example, some or all of the information the advertiser entered into submission fields when the advertiser submitted an advertisement request form. The editor may review this information to verify the integrity of the information. For example, the editor may verify the address and phone number associated with the mobile advertisement listing. The editor may also verify that the destination URL associated with the mobile advertisement exists.

An editor may utilize the mobile device emulator 1015 to verify that the mobile advertisement listing appears correct on a given device. In some implementations, the editor may be able to select to emulate the mobile advertisement listing on a device based on those devices available from a particular carrier. The emulator typically emulates the display characteristics of a selected device such as a number of pixels on a display of the device or a color capability of a display of the device (color vs. black and white).

The carrier rules list box 1020 may provide information to the editor related to the checks the editor may have to perform on the mobile advertisement listing. In some implementations, the rules may vary from carrier to carrier. For example, one carrier may allow adult themed advertisement while another may not. The carrier rules list box 1020 may also indicate, for example, a maximum number of allowable characters for a given device.

The editor may utilize the disposition list box 1025 to indicate whether the mobile advertisement listing is acceptable. In the case where a mobile advertisement listing may not be acceptable, the editor may provide a reason. For example, the editor may find that inappropriate language may be used in a mobile advertisement listing. If the rules for the particular carrier prohibit such language, the editor may note that in the reason field of the disposition list box 1025.

After reviewing the mobile advertisement listing, an editor may submit the status of the review by pressing the submit button 1030. Where a reason for rejecting a mobile advertisement listing is given, the advertiser may be notified of the rejection. For example, an email may be sent to the advertiser alerting the advertiser that an editor has rejected the mobile advertisement listing. Pressing the submit button 1030 may also update a status field on a user interface for providing mobile advertisement listing status to advertisers. When the mobile advertisement listing meets all of the requirements of a particular carrier, pressing the submit button 1030 may result in the mobile advertisement listing being published so that the mobile advertisement listing may be served to users in response to actions such as users submitting search queries or viewing particular websites.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of filtering mobile ads, comprising:
sensing an editorial event from an advertiser user interface, wherein the editorial event comprises an advertiser creating or editing a mobile advertisement listing;
enabling submission of the mobile listing with a plurality of channel and carrier attributes;
automatically checking the mobile listing with at least one mobile carrier-specific automatic check service in response to the sensed editorial event;
determining whether the advertisement listing is flagged for manual review; and
sending the mobile listing to a mobile publisher for publishing in response to a determination that the mobile listing is not flagged for manual review.

2. The method of claim 1, wherein the editorial event comprises one or more of the advertiser: submitting or modifying keyword-level uniform resource locator (URL) overrides; adding a keyword; and creating or editing an advertisement associated with the mobile listing.

3. The method of claim 1, further comprising:
routing the mobile listing to a mobile editor for manual review in response to a determination that the mobile listing is flagged for manual review;
determining if the mobile editor approves the mobile listing based on mobile carrier-specific criteria; and
sending the mobile listing, or an update thereto, to the mobile publisher for publishing in response to an approval of the mobile listing by the mobile editor.

4. The method of claim 3, further comprising:
enabling the mobile editor to select a rolled-up review option to review the mobile listing according to a plurality of available carriers.

5. The method of claim 3, further comprising:
enabling the mobile editor to review the mobile listing by reviewing an aspect of the mobile listing selected from the group consisting of terms, creatives, a uniform resource locator (URL), and a relationship.

6. The method of claim 5, wherein the manual review is mobile carrier-specific, the method further comprising:
enabling the mobile editor to assign a carrier-specific editorial status; and
communicating the carrier-specific editorial status to the advertiser through the user interface or via an e-mail.

7. The method of claim 5, further comprising:
enabling selection by the mobile editor of a carrier-specific reject reason in response to a disapproval of the mobile listing by the mobile editor; and
communicating the carrier-specific reject reason to the advertiser through the user interface.

8. The method of claim 7, further comprising:
removing the mobile listing from an ad server in response to the disapproval of the mobile listing by the mobile editor or by the at least one automatic check service.

9. The method of claim 8, wherein the at least one automatic check is selected from the group consisting of a format check, a risk terms check, and a market-specific terms list check.

10. The method of claim 9, wherein the format check is executed with comparison to a carrier-specific format dataset, including a field length specific to each carrier.

11. The method of claim 9, wherein the risk terms check is executed with comparison to a carrier-specific risk dataset of terms or creatives selected from the group consisting of adult, gambling, blocked, suspect, trademarks, and prescription drugs subject matter.

12. The method of claim 9, wherein the market-specific terms list check is executed with comparison to a carrier-specific dataset that is also specific to a geographic market.

13. The method of claim 8, further comprising:
enabling the removed mobile listing to be resubmitted; and
executing persistent check services (PCS) to identify a mobile listing that has been resubmitted in addition to the carrier-specific reject reason.

14. A system for filtering mobile ads, comprising:
a memory to store instructions, a mobile carrier data and an advertisement data;
a user interface operatively connected to the memory to communicate with advertisers that use a mobile device or a web-based computer; and
a processor operatively connected to the memory and the user interface to execute the instructions, wherein the processor senses an editorial event comprising an advertiser creating or editing a mobile advertisement listing through the user interface;
wherein in response to the sensed editorial event, the processor:
enables submission of the mobile listing with a plurality of channel and carrier attributes;
automatically checks the mobile listing with at least one mobile carrier-specific automatic check service;
flags an advertisement for manual review if the automatic check of the mobile listing indicates that content or format of the mobile listing matches that of a carrier-specific dataset of the at least one automatic check service; and
sends the mobile listing to a mobile publisher for publishing if the mobile listing is not flagged for manual review.

15. The system of claim 14, wherein the editorial event comprises one or more of the advertiser: submitting or modifying keyword-level uniform resource locator (URL) overrides; adding a keyword; and creating or editing an advertisement associated with the mobile listing.

16. The system of claim 14, wherein the processor:
routes the mobile listing to a mobile editor for manual review in response to a determination that the mobile listing is flagged for manual review;
determines if the mobile editor approves the mobile listing; and
sends the mobile listing, or an update thereto, to the mobile publisher for publishing in response to an approval of the mobile listing by the mobile editor.

17. The system of claim 16, wherein the processor:
enables the mobile editor to select a preferred carrier on which to focus the manual review.

18. The system of claim 16, wherein the processor:
enables the mobile editor to review the mobile listing by reviewing an aspect of the mobile listing selected from the group consisting of terms, creatives, a uniform resource locator (URL), and a relationship; and
enables the mobile editor to disapprove of the mobile listing if the mobile listing fails to meet a criteria of the aspect of the mobile listing.

19. The system of claim 18, wherein the manual review is mobile carrier-specific, and wherein the processor:
enables the mobile editor to assign a carrier-specific editorial status; and
communicates the carrier-specific editorial status to the advertiser through the user interface or via an e-mail or a text message.

20. The system of claim 18, wherein the processor:
enables selection of a carrier-specific reject reason by the mobile editor in response to a disapproval of the mobile listing by the mobile editor; and
communicates the carrier-specific reject reason to the advertiser through the user interface or via an e-mail or a text message.

21. The system of claim 20, further comprising:
a research quality control console (RQCC) to scrub inappropriate content from the mobile listing or to remove the mobile listing if the mobile listing is already published.

22. The system of claim 21, wherein the processor:
enables the disapproved, removed, or scrubbed mobile listing to be resubmitted; and
executes persistent check services (PCS) to identify a mobile listing that has been resubmitted in addition to the carrier-specific reject reason.

23. The system of claim 14, wherein the at least one carrier-specific automatic check is selected from the group consisting of a format check, a risk terms check, and a market-specific terms list check, and wherein the carrier-specific dataset is compiled from a format dataset, a risk dataset, or from a market-specific dataset.

24. The system of claim 23, wherein the risk dataset comprises terms or creatives relating to adult content, gambling content, blocked content, suspect terms, trademarks, or prescription drugs, wherein the blocked content is derived from a partner block list that is mobile carrier-specific.

25. The system of claim 23, wherein the market-specific dataset comprises inappropriate content specific to a geographic market or to a specific carrier.
